(19) United States
(12) Patent Application Publication
(10) Pub. No.: US 2019/0364611 A1
(43) Pub. Date: Nov. 28, 2019

(54) Interface Setup Between A Radio Access Network And A Core Network

(71) Applicant: Telefonaktiebolaget LM Ericsson (publ), Stockholm (SE)

(72) Inventors: Angelo Centonza, Stockholm (SE); Elena Myhre, Järfälla (SE); Alexander Vesely, Feldbach (AT)

(21) Appl. No.: 16/324,603

(22) PCT Filed: Aug. 14, 2017
(86) PCT No.: PCT/EP2017/070605

§ 371 Date: Feb. 11, 2019

(51) Int. Cl. H04W 76/16

(52) U.S. Cl. CPC H04W 76/16; H04W 92/20

(57) ABSTRACT

A radio access network (RAN) node (420) and core network (CN) node (405) each support signaling connection establishment for a user equipment (UE) (320, 325). In particular, the RAN node (420) and CN node (405) establish an interface (770) supporting signal exchange between the RAN node (420) and a plurality of core networks (CNs) supported by a CN node (405). Responsive to the RAN node (420) receiving an indication that the UE (320, 325) supports one or more of the CNs (120, 710) supported by the CN node (405), the RAN node (420) establishes, between the RAN node (420) and a given CN supported by both the CN node (405) and the UE (320, 325), a signaling connection for the UE (320, 325) over the interface (770). Responsive to receiving an initial UE message for establishing the signaling connection, the CN node (405) transmits a UE context message to the RAN node (420) for establishing the signaling connection over the interface (770) irrespective of which of the plurality of CNs (120, 710) is the given CN.

### RELATED APPLICATIONS

This application claims the benefit of U.S. Provisional Patent Application Ser. No. 62/374629, filed 12 Aug. 2016, the entire contents of which are incorporated by reference herein.

### TECHNICAL FIELD

The present disclosure generally relates to a radio communications network comprising a radio access network (RAN) node and a core network (CN) node, and more particularly to interface and application functions between the RAN and a plurality of CNs.

### BACKGROUND

In a typical wireless communications network (e.g., a cellular network). wireless terminals, also known as mobile stations or user equipments (UEs) communicate via a Radio Access Network (RAN) to one or more core networks. The RAN may comprise a plurality of access nodes (e.g., base stations) that communicate with the wireless terminals or UEs by means of radio signals and provide access to the CN.

The Third Generation Partnership Project (3GPP) has established a plurality of generations of mobile communication standards. The Universal Mobile Telecommunications System (UMTS) is a third generation mobile communication system, which evolved from the Global System for Mobile Communications (GSM) to provide mobile communication services based on Wideband Code Division Multiple Access (WCDMA) access technology. Long-Term Evolution (LTE) often being referred to as fourth generation, has been specified to increase the capacity and speed using orthogonal frequency division multiplexing (OFDM) in the downlink and Discrete Fourier Transform (DFT)-spread OFDM, also being referred to as single-carrier frequency-division multiple access (SC-FDMA) in the uplink.

3GPP is currently working on enhancing the LTE concept. A sketch architecture of the LTE system 100 is shown in FIG. 1, by way of example showing RAN nodes 105a-h (eNBs 105a-c, Home eNBs (HeNBs) 105d-f, HeNB gateway (SW) 105g, X2 GW 105h) and evolved packet core (EPC) nodes 110a-c (specifically, mobility management entities/signaling gateways (MME/S-GL's)). As it can be seen, S1 interfaces connect HeNBs/eNBs 105a-d to the MME/S-GWs 110a-b and HeNBs 105e-f to the HeNB GW 105g, while an X2 (and optionally X5) interface connects peer eNBs/HeNBs 105a-f, (optionally via an X2 GW 125). S1 procedures are defined in T536.413 (e.g., Release 13.3.0).

The S1 interface is adapted to carry the S1 Application Protocol, S1AP, providing the signaling service between the Evolved Universal Terrestrial Radio Access Network (E-UTRAN) 115 and the EPC 120 and may support one or more of the following functions (as currently specified by 3GPP): E-UTRAN Radio Access Bearer (E-RAB) management function; Initial Context Transfer function; User Equipment (UE) Capability Info Indication function; Mobility Functions: S1 interface management functions; Non-Access-Stratum (NAS) signaling transport function; S1 UE context Release function; UE Context Modification function; Status Transfer; Trace function; Location Reporting; S1 CDMA2000 Tunneling function; Warning message transmission function; RAN Information Management (RIM) function: and/or Configuration Transfer function.

The X2 interface is adapted to carry the X2 Application Protocol, X2AP, to handle UE mobility within the E-UTRAN 115, and may support one or more of the following functions (as currently specified by 3GPP): Mobility Management; Load Management; Reporting of General Error Situations; Resetting the X2; Setting up the X2: eNB Configuration Update.

FIG. 2 shows an example management system 200 to manage node elements (NEs) 205a-c shown in FIG. 1. The NEs 205a-b (i.e., the eNBs) may be managed by a domain manager (DM) 210a, such as an operation and support system (OSS). The NE 205c (i.e., the HeNB) may be managed by a DM 210b, such as a HeNB Management System (HMS). The DMs 210a-b may further be managed by a network manager (NM) 215. The eNB NEs 205a-b are interfaced by X2, whereas the interface between the DMs 210a-b is referred to as Itf-P2P according to 3GPP. The management system 200 may configure the NEs 205a-c, as well as receive observations associated to features in the NEs 205a-c. For example, DM 210a observes and configures NEs 205a-b, while NM 215 observes and configures DM 210a, as well as NE 205c via DM 210b.

By means of configuration via the DMs 210a-b, NM 215 and related interfaces, functions over the X2 and S1 interfaces may be carried out in a coordinated way throughout the RAN, eventually involving the CN, e.g. the MME and/or the S-GWs 110.

In FIG. 3 two CN systems 120, 310 are represented. One of the CN systems is the EPC 120 which is the CN that serves the LTE eNB 305 and Legacy UE 320. The other is being referred to as 5G CN 310. This 5G CN 310 is the CN that serves New Radio (NR) base station (BS) 315 and 5G (or later)-capable UE 325. As shown, these two CNs 120, 310 are connected to different RANs (i.e., an LTE RAN that includes LTE eNB 305, and an NR RAN that includes NR BS 315).

More particularly, FIG. 3 shows an example communication system 300 comprising a first CN represented by EPC 120 (being specified by 3GPP), and a second CN represented by a 5G CN 315 that is currently under specification development. FIG. 3 further shows a first radio access network (such as an LTE RAN as represented in FIG. 3 by an LTE eNB 305, as specified by 3GPP), and a second RAN (as represented by NR BS 315, that is currently under specification development).

As depicted in FIG. 3 as an example, the LTE eNB 305 is capable of serving UEs that have capabilities to connect to legacy LTE systems, but not to an evolution of E-UTRA or eLTE that is currently developed by 3GPP (also referred to as legacy UEs 320), by establishing an S1 control plane (CP) and user plane (UP) connection to the EPC.

The LTE eNB 305 may further be capable of serving new or 5G UEs 325, namely UEs that are capable of connecting to new generation services and features via an LTE radio interface by establishing a next generation (NG) or NG1 CP (and UP) connection to the EPC. Such LTE may be also being referred to evolved LTE (eLTE). It may be further assumed that the eLTE is downward compatible so that it may serve legacy UEs 320 and 5G UEs 325 at the same time.

The NR BS 315 may also been regarded as a (logical) radio node supporting next generation (e.g., 5G or later G) radio technologies and interfacing with the 5G CN 310. This node is capable of serving 5G UEs 325 by establishing a next generation or NG1 CP (and UP) connection to the 5G CN 310. Namely the NR BS 315 supports new generation services and features via a next generation radio interface.

As described above, a 5G UE 325 may connect via a RAN node that supports either the evolution of LTE for next generation networks or the new radio interface for next generation radio systems. For such 5G UE 325, an NG1 CP signaling connection and eventually an NG1 UP connection will be established between the serving RAN node and the 5G CN 310. The NG1 interface is herein defined as the interface terminating at the 5G CN 310, which supports new procedures and functions specific of next generation 5G systems. The NG1 may be based on the S1 interface comprising one or a plurality of common functions or may have different functions compared to the S1 interface.

As discussed above, an eLTE eNB may be required to support multiple interfaces towards the EPC 120 and the 5G CN 310 at the same time. Such requirement may have some or all of the following consequences: higher number of transport layer protocol instances; design of a double upper layer protocol stack; problems on selection of an appropriate interface for a connecting UE 320, 325; and/or need to pre-configure knowledge in the RAN and the CN about network capabilities.

With respect to a potential need for higher number of transport layer protocol instances, this may include for each connection towards the EPC 120 or the 5G CN 310, the need of a new instance of a transport layer protocol association, e.g., a Stream Control Transmission Protocol (SCTP) association. Assuming that legacy UEs 320 will remain in use for a long time ahead, connections towards the EPC 120 and the 5G CN 310 may have to be maintained in parallel for a long time, placing higher design requirements on eNBs, e.g., the need to support double the number of SCTP connections.

With respect to a potential need for a design of a double upper layer protocol stack, two upper layer protocols, such as the S1AP and the NG1AP, may need to be maintained at the same time. These protocols would each need procedures that are likely to be common to both interfaces; e.g. Interface management procedures, UE Context Management Procedures and Mobility Procedures. Such approach may require a duplication of design effort.

With respect to problems on selection of an appropriate interface for a connecting UE 320, 325, a UE 320, 325 that connects to the network and for which a context has not yet been created is likely to present its set of capabilities as part of Radio Resource Control (RRC) signaling to the RAN. However, the choice of an interface (and CN node) for such UE 320, 325 may not be deduced from such information because such choice depends on the services the UE 320, 325 is subscribed to. As an example, a 5G capable UE 325 may be only subscribed to LTE services in the same way as current networks allow an LTE capable UE 320 to only consume 3G services. If it is assumed that a UE 320, 325 has to be connected to the CN via either an S1 or an NG1 interface, the selection of the right interface becomes problematic. Indeed, a RAN-CN signaling connection via S1 or NG1 can only be selected after the CN has received a request for connection establishment from the RAN and has selected the interface (and therefore services) that can be used based on the UE subscription information.

With respect to a potential need to pre-configure knowledge in the RAN and the CN about network capabilities, besides the variety of UE capabilities and subscriptions there is also the issue of network capabilities and level of support. With an addition of the 5G capable RAN-CN interface to the legacy CN-RAN interface, there may be a need to configure CN and RAN to be aware of which CN and RAN nodes are only supporting legacy/S1 functionality.

### SUMMARY

According to embodiments of the present disclosure, a radio access network (RAN) node and core network (CN) node each support signaling connection establishment for a user equipment (UE). In particular, the RAN node and CN node establish an interface supporting signal exchange between the RAN node and a plurality of CNs supported by a CN node. Responsive to the RAN node receiving an indication that the UE supports one or more of the CNs supported by the CN node, the RAN node establishes, between the RAN node and a given CN supported by both the CN node and the UE, a signaling connection for the UE over the interface. Responsive to receiving an initial UE message for establishing the signaling connection, the CN node transmits a UE context message to the RAN node for establishing the signaling connection over the interface irrespective of which of the plurality of CNs is the given CN.

One or more embodiments described herein comprise a method, implemented in a radio access network (RAN) node, of supporting signaling connection establishment for a user equipment (UE). The method comprises establishing an interface supporting signal exchange between the RAN node and a plurality of core networks (CNs) supported by a CN node. The method further comprises, responsive to receiving an indication that the UE supports one or more of the CNs supported by the CN node, establishing, between the RAN node and a given CN supported by both the CN node and the UE, a signaling connection for the UE over the interface.

In some embodiments, establishing the signaling connection over the interface comprises sending, from the RAN node to the given CN, an initial UE message and receiving, at the RAN node from the given CN in response, a UE context message.

In one or more of the preceding embodiments, the indication that the UE supports one or more of the CNs supported by the CN node comprises an indication that the UE supports legacy Long-Term Evolution (LTE) functions, evolved LTE functions, and/or new radio (NR) functions.

In one or more of the preceding embodiments, herein the information that the UE supports one or more of the CNs supported by the CN node comprises an indication that the UE supports LTE non-stratum access (NAS) protocol or next generation NAS protocol.

In one or more of the preceding embodiments, establishing the signaling connection for the UE over the interface comprises initiating creation of a context for the UE.

In one or more of the preceding embodiments, establishing the signaling connection for the UE over the interface comprises selecting between a first and a second protocol for the signaling connection, each of the first and second protocols supporting signal exchange between the RAN node and a respective CN supported by the CN node. In some such embodiments, the first protocol is S1 Application Protocol and the second protocol is a next generation network layer signaling protocol.

Embodiments described herein also comprise a method, implemented in a core network (CN) node, of supporting signaling connection establishment for a user equipment (UE). The method comprises establishing an interface supporting signal exchange between a plurality of CNs supported by the CN node and a radio access network (RAN) node. The method further comprises responsive to receiving an initial UE message for establishing a signaling connection between the RAN node and a given CN of the plurality of CNs for the UE, transmitting, to the RAN node from the CN node, a UE context message for establishing the signaling connection over the interface irrespective of which of the plurality of CNs is the given CN.

In some embodiments, establishing the signaling connection over the interface comprises receiving, from the RAN node, an initial UE message and transmitting, to the RAN node from the given CN, a UE context message in response.

In some embodiments, establishing the signaling connection for the UE over the interface comprises initiating creation of a context for the UE.

In some embodiments, establishing the signaling connection for the UE over the interface comprises using either a first or a second protocol for the signaling connection based on whether the given CN is a first or a second one of the plurality of CNs, respectively. In some such embodiments, the first protocol is S1 Application Protocol and the second protocol is a next generation network layer signaling protocol.

In any of the preceding embodiments, establishing the interface may comprise establishing a Stream Control Transmission Protocol association between the RAN node and the CN node as endpoints.

Embodiments herein include corresponding apparatus, computer programs, and carriers. For example, embodiments herein also include a RAN node supporting signaling connection establishment for a UE. The RAN node is configured to establish an interface supporting signal exchange between the RAN node and a plurality of CNs supported by a CN node. The RAN node is further configured to, responsive to receiving an indication that the UE supports one or more of the CNs supported by the CN node, establish between the RAN node and a given CN supported by both the CN node and the UE, a signaling connection for the UE over the interface.

As another example, embodiments herein also include a CN node supporting signaling connection establishment for a user equipment (UE). The CN node is configured to establish an interface supporting signal exchange between a plurality of CNs supported by the CN node and a radio access network (RAN) node. The CN node is further configured to, responsive to receiving an initial UE message for establishing a signaling connection between the RAN node and a given CN of the plurality of CNs for the UE, transmit, to the RAN node from the CN node, a UE context message for establishing the signaling connection over the interface irrespective of which of the plurality of CNs is the given CN.

### BRIEF DESCRIPTION OF THE DRAWINGS

FIG. 1 illustrates an example LTE architecture showing (logical) interfaces between radio access nodes and core network nodes.

FIG. 2 shows an example management system architecture.

FIG. 3 shows an example architecture example for serving legacy and 5G UEs via different interfaces.

FIG. 4 shows an example radio network, wherein legacy and new 5G UEs are served by a unique interface, according to some embodiments of the present disclosure.

FIG. 5 shows an example sequence for a RAN-CN interface procedure selection, according to some embodiments of the present disclosure.

FIG. 6 shows an example of a RAN—CN interface setup, according to some embodiments of the present disclosure.

FIG. 7A-F show different RAN—CN interface scenarios, according to some embodiments of the present disclosure.

FIG. 8A shows a first block diagram showing example structural units of a RAN node according to some embodiments of the present disclosure.

FIG. 8B shows a second block diagram showing example functional units of the RAN node according to some embodiments of the present disclosure.

FIG. 9 is a flow diagram illustrating an example method implemented in a RAN node, according to one or more embodiments of the present disclosure.

FIG. 10 is a flow diagram illustrating an example method implemented in a CN node, according to one or more embodiments of the present disclosure.

FIG. 11 is a flow diagram illustrating a further example method implemented in a RAN node, according to one or more embodiments of the present disclosure.

FIG. 12 is a block diagram illustrating example hardware, according to one or more embodiments of the present disclosure.

FIG. 13 is a block diagram illustrating example components, according to one or more embodiments of the present disclosure.

FIG. 14 is a block diagram illustrating different example components, according to one or more embodiments of the present disclosure.

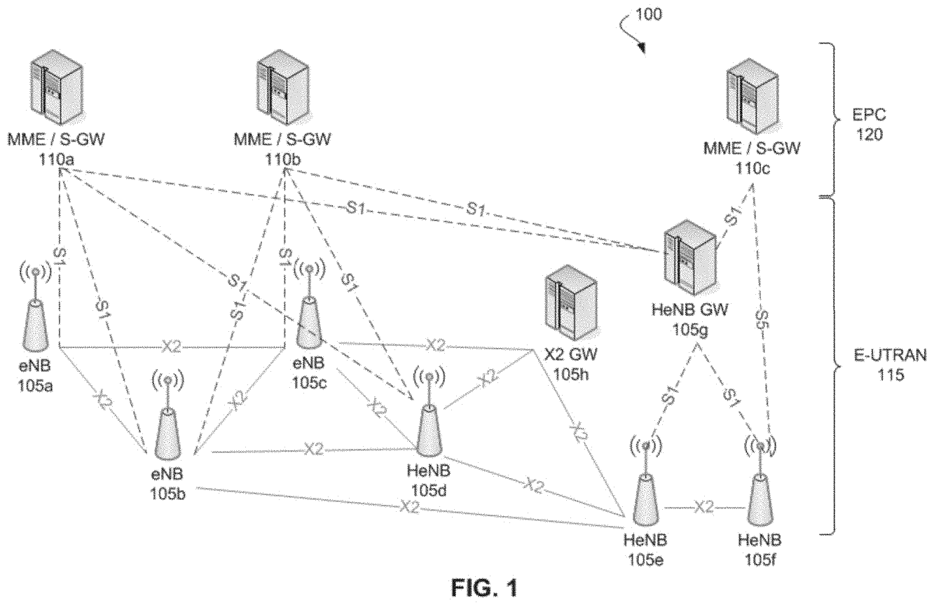

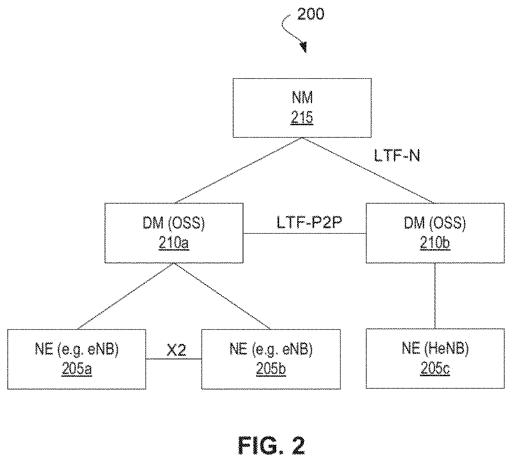

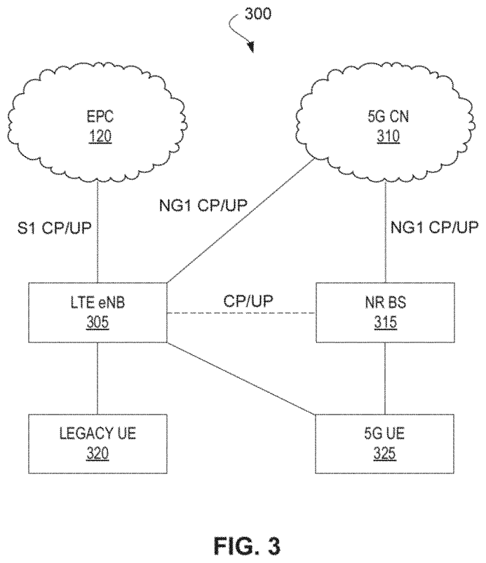

### DETAILED DESCRIPTION

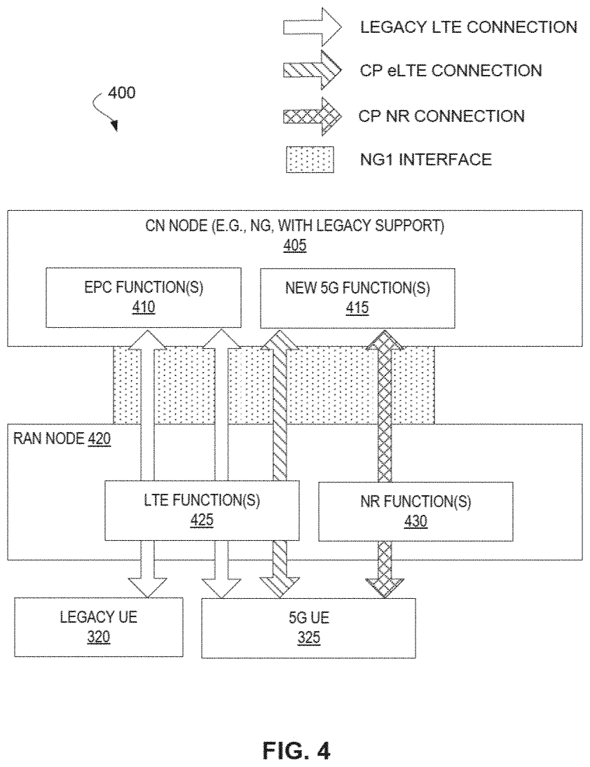

FIG. 4 shows an example radio network 400 comprising a CN node 405, a RAN node 420, a legacy UE 320, and a 5G UE 325. The CN node 405 comprises EPC functions 410 (being specified by 3GPP) and new 5G functions 415 (being at least partly under specification development). Thus, the same CN node 405 supports functions of multiple CNs EPC and 5G, according to this example). The RAN node 420 (e.g., a 5G RAN node) comprises LTE functions 425 (and/or eLTE functions) and NR functions 430. According to this example, the legacy UE 320 is capable of LTE, and the 5G UE 325 is capable of LTE, eLTE and NR.

An LTE (or LTE capable) UE 320 may, in this example, be regarded as a UE that is able to support legacy E-UTRA and EPS services. A 5G (or 5G capable) UE 325 may be regarded as a UE that is able to support an evolved E-UTRA and 5G services and procedures (and “legacy” E-UTRA). In this context eLTE technologies may be considered to be part of 5G systems. An NR (or NR capable) UE may be regarded as a UE that is able to support a New Radio (NR) interface, e.g. 5G services.

A similar description given above for UEs can be given for RAN functionality. In particular, an eLTE RAN function 425 is a RAN function that supports evolved E-UTRA/E-UTRAN features. Such evolution may be realized in a backward compatible way, such that “legacy” E-UTRAIE-UTRAN features are comprised. An NR RAN function 430 is a RAN function that supports the NR radio interface and associated features. By way of example, in FIG. 4, the two types of RAN functions 425, 430 are combined in the same (logical) RAN node 420. Namely, the functions and interfaces supported by the logical RAN node 420 may be a combination of those supported by an eLTE eNB node and those supported by an NR BS. Similar principles may apply to the CN node 405. This system supports functions 410, 415 for both the EPC and the 5G CN, respectively. Accordingly, functions 410 already supported in the EPC may be reused to serve 5G capable UEs.

As depicted in FIG. 4 the radio network 400 serves both legacy UEs 320 and 5G UEs 325 via a single RAN-CN interface. This interface supports procedures that are shared for the legacy and 5G UE 320, 325 as well as procedures that are specific to either the legacy UE 320 or the 5G UE 325. In other words, the procedures of both categories of UE may both be supported over the interface. According to embodiments, the interface is established between the CN node 405 and RAN node 420 as endpoints of the same transport layer association (e.g., the same SCTP association). According to a particular example, such an interface is capable of support (existing) S1 protocol functions to serve legacy UEs 320, and new functions procedures to serve 5G UEs 325. For convenience this interface is also being referred to as NG1 in this specification.

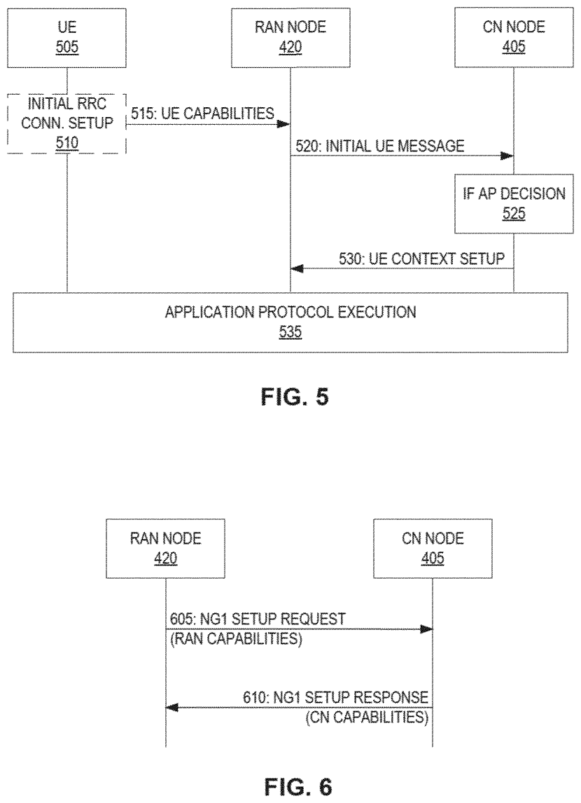

FIG. 5 shows a sequence of steps and functions being performed by the nodes of FIG. 4. wherein the UE 605 may be either a legacy UE 320 or a 5G UE 325. In particular, the UE 505 indicates its capabilities to the RAN (step 515). Such capabilities may comprise an indication that the UE 605 supports legacy LTE functions and procedures, and/or evolved LTE functions and procedures, and/or new radio (NR) functions and procedures.

Additionally, in case of a UE 505 that is able to support both LTE functions and procedures and NR functions and procedures, the UE may indicate what procedures/protocols it is following. As an example, the UE 505 may indicate whether it is using LTE NAS (non-stratum access) protocol or next generation NAS protocol.

Such indication may be sent to the RAN when the UE 505 connects to the radio system, for example as part of the RRC Connection Setup procedure (step 510). According to 3GPP specifications, the RRC Connection Setup Procedure may comprise the following two messages (not shown): Message (Msg) 4 (RRC Connection Setup) from RAN to UE 505; and Message (Msg) 5 (RRC Connection Setup Complete) from UE 505 to RAN.

By way of example, Message 5 may be generated to comprise information about UE capabilities about a support of radio technologies (e.g. support for one, some or all of LTE, eLTE, NR, etc.). Further, information about procedures and protocols used by the UE 505 may be comprised (RRC version, NAS version, etc.).

Next, based on the UE capabilities and/or on knowledge of procedures followed by the UE 505, the RAN node 420 may select a CN node 405 to send an initial UE message to for establishing a signaling connection between RAN and CN for this UE 505 (step 520). Once the RAN 420 knows the UE capabilities for a UE 505 connecting to the RAN, the RAN may initiate procedures towards the CN in order to establish a signaling connection with the CN for such UE 505.

Accordingly, the RAN node 420 generates an Initial UE Message towards the CN, i.e., a message in which the signaling connection is initiated. This message may be routed towards one CN node 405 of a plurality of CN nodes (not shown) that matches the UE capabilities and functions used by the UE 505. In this message the RAN may indicate to the CN the UE capabilities received in step 1. The initial UE message comprises an indication of UE capabilities (and the used NAS version) to the CN node 405. The knowledge of procedures followed by the UE 505 may be derived from information about the capabilities supported by each connected CN node 405 at interface setup.

As the CN and RAN might have negotiated during interface setup whether to operate in ‘legacy/S1 mode’ or not, there is a possibility, when designing/specifying the NG1 signaling protocol, to differentiate the legacy Initial UE Message (which does not need to be evolved with non-backwards compatible changes) from a new Initial UE Message (or other name), which can be defined without compatibility concerns. In principle it may be advantageous to early negotiate a mode of operation thus allowing for independence and at the same time co-existence of legacy and new functionality. Once the CN receives the Initial UE Message. the CN node 405 performs a check of UE subscription (e.g., to make an interface application protocol decision based on the UE subscription, whether such subscription may be to an LTE, 5G, or other system) (step 525).

The CN node 405 may then respond with a UE context message that finalizes the establishment of a signaling connection and/or that initiates the creation of a context and allocation of needed resources for the UE 505 (step 530).

The message from the CN to the RAN described above comprises an indication of the procedures the CN prefers or requests to serve the UE 505. Namely, the choice can be between S1AP procedures or Next Generation AP procedures. Such choice may be made by the CN on the basis of the capabilities indicated by the UE 505 (received from the RAN), on the basis of the NAS message received from the UE 505, which indicates a UE identity that allows to retrieve UE subscriber's information and that request a specific service and on the basis of retrieved UE subscriber information that may be obtained from a subscriber's information repository upon reception of the NAS PDU for the UE 505.

Application protocol (AP) execution between RAN and CN is performed depending on the decision indicated in the UE context message (step 535). As an example, the UE 505 might have indicated support for 5G capabilities, but it is subscribed to usage of the legacy LTE services only. For such UE 505, the CN node 405 may indicate in the UE context message that the UE 505 will be served by means of LTE S1 procedures. On reception of such indication the RAN and CN exchange S1 messages to serve the connected UE 505. Such indication may further recommend or request to serve the UE 505 via legacy LTE procedures over the radio interface.

FIG. 6 shows an example sequence for to be performed by the RAN node 420 and CN 405 to exchange information to enable a setup of the NG1 interface. As part of these messages, the RAN may inform the CN of the supported capabilities, e.g. whether the RAN supports the NR radio interface and associated functions and procedures and/or the LTE radio interface and associated functions and procedures and/or the evolved LTE radio interface and associated functions and procedures, and potentially an expected mode for the NG1 interface to work (e.g. S1-like or evolved).

Similarly, the CN may reply to the RAN with its own supported capabilities. This may consist of support of next generation (5G) associated functions and procedures, including support of the next generation NAS protocol, and/or LTE and associated functions and procedures.

Accordingly, in a first message, the RAN may convey a NG1 setup request to the CN comprising RAN capabilities (step 605). In a second message, the CN may indicate to the RAN what functions it supports (CN capabilities) (step 610). Namely, the response from the CN may indicate to the RAN whether it supports 5G UEs or whether it supports LTE UEs or both. The response may further comprise an indication about a mode to be used for the NG1 signaling protocol, e.g. if the interface should work in ‘LTE mode’ or in ‘5G mode’.

If the NG1 interface should work in ‘LTE mode’, it may basically work as an S1-MME interface, being specified as interface between the E-UTRAN 115 and the MME 110 according to 3GPP. This may be particularly important for various reasons. One reason may be letting the RAN know the type of Non Access Stratum (NAS) protocol the CN supports. It may be possible that different NAS protocols are available for UEs 505 that want to access the 5G system and for UEs 505 that access the legacy LTE system.

It is generally suggested to let the RAN know relevant capabilities of the CN node 405 connecting to it, so that depending on the UE capabilities, the RAN is able to route a connection request from a UE 505 to the right node. The interface setup procedures may be similar to the S1 Setup procedures as established in LTE (in particular, the first message sent over the interface may be be defined so that it is possible for a legacy recipient to receive it correctly, even though it supports no 5G functionality).

S1 procedures describe all the RAN to CN communication enabled for LTE. Specification of the new RAN-CN interface is still under development. As one example for differences between S1 and NG1. NG1 may include a new way to describe Quality of Service (QoS) comprising a new procedure for the management of radio bearers and QoS. Such new procedures differ from the previous ones in that they may allow a management of data flow and Packet Data Unit Sessions, rather than management of enhanced Radio Access Bearers, which can carry traffic of many data flows.

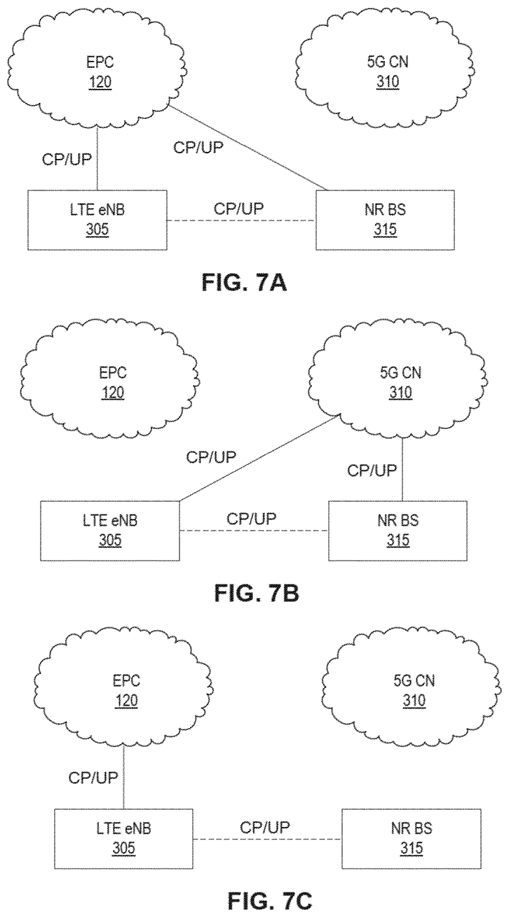

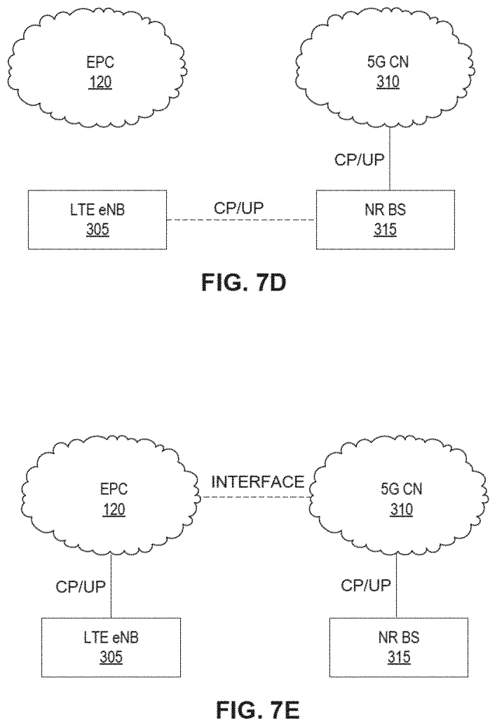

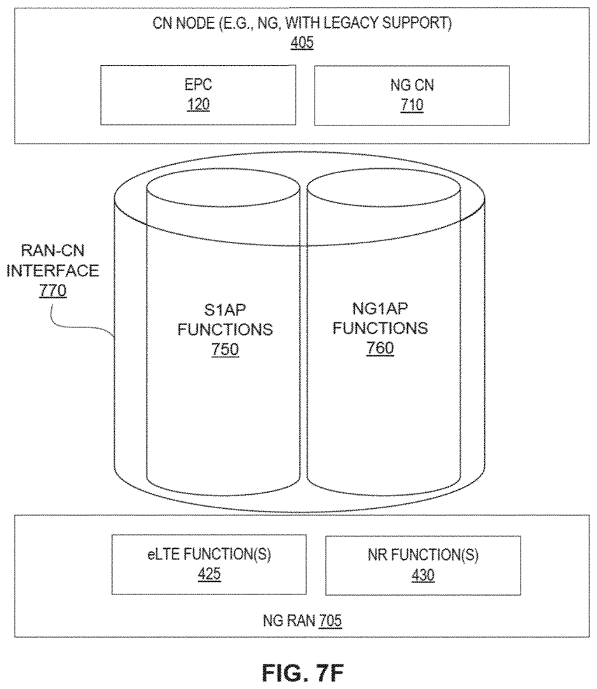

In FIGS. 7a-7f, different RAN-CN interface deployment scenarios for connectivity between a RAN consisting of evolved LTE (eLTE) and NR and a CN consisting of a 5G CN 310 and an (evolved) EPC 120 are shown. In particular, FIG. 7a illustrates eLTE eNB 305 and NR BS 315 connected to the EPC 120. FIG. 7b illustrates eLTE and NR connected to the 5G CN. In some such embodiments, eLTE eNB and NR BS may be collocated. FIG. 7c illustrates eLTE connected to the EPC, and NR interworking with LTE via inter node interface. FIG. 7d illustrates NR connected to the 5G CN, and LTE interworking with NR via inter node interface. FIG. 7e illustrates NR connected to the 5G CN, and eLTE connected to the EPC. In this scenario, there may be an interface between the EPC 120 and the 5G CN 310.

in FIG. 7f, eLTE and NR RAN nodes/functions 425, 430 are connected to the NG CN 710 and EPC 120 via a RAN-CN interface 770 supporting S1 and NG1 AP functions/procedures 750, 760.

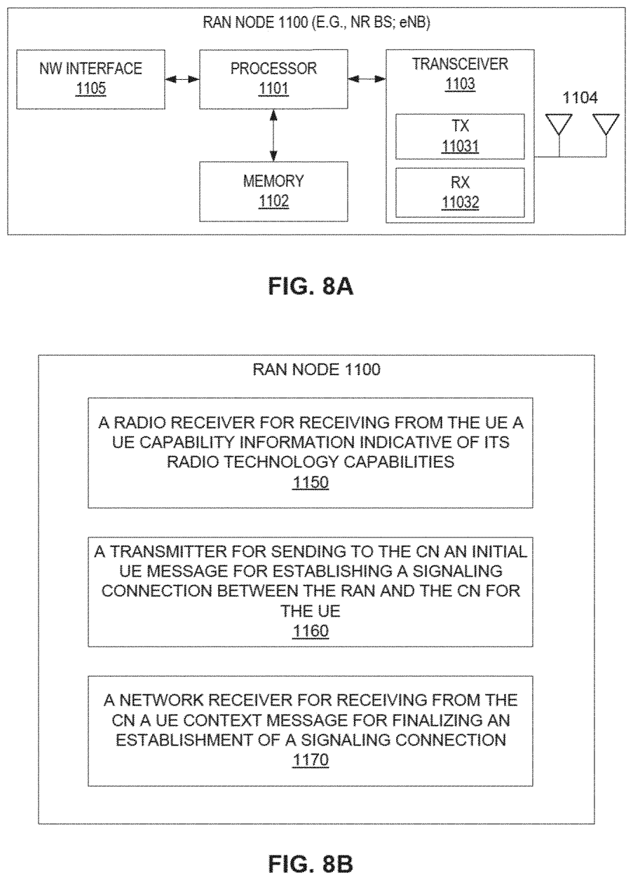

As shown in FIG. 8A, a RAN node 1100 includes a node processor 1101, a node memory 1102, a node transceiver 1103, one or a plurality of node antennas 1104, and a network interface 1105. The node processor 1101 is coupled to the node memory 1102, to the network interface 1105, and to the node transceiver 1103. The node transceiver 1103 is further coupled to the one or the plurality of node antennas 1104. The node transceiver 1103 comprises a transmission circuit TX 11031 and a receiver circuit RX 11032. In particular embodiments, some (or all) of the functionality described above as being provided by eNB may be provided by the node processor 1101 executing respective instructions stored on a computer-readable medium, such as the node memory 1102.

Alternative embodiments of the RAN node 1100 (e.g., NR BS; eNB) may include additional components responsible for providing additional functionality, including any of the functionality identified above and/or any functionality necessary to support the solution described above.

As shown in FIG. 8b, the RAN node 1100 includes the following example functional units: a radio receiver 1150, a transmitter 1160, and a network receiver 1170. The radio receiver 1150 is for receiving from the UE 505 a UE capability information indicative of its radio technology capabilities. Such information may comprise an indication that the UE 505 supports legacy LTE functions and procedures, and/or evolved LTE functions and procedures 425, and/or new radio (NR) functions and procedures 430. The transmitter 1160 is for sending to the CN an initial UE message for establishing a signaling connection between the RAN and the CN for this UE 505. The network receiver 1170 is for receiving from the CN a UE context message for finalizing an establishment of a signaling connection and/or initiating a creation of a context and allocation of needed resources for the UE 505.

One or more of the embodiments described herein allow for a definition of a single interface 770 between the RAN and the CN, such interface 770 being able to serve both legacy UEs 320 and 5G UEs 325. Further embodiments facilitate procedures of mobility for UEs 505 that need to change serving CN system, for example from the EPC 120 to the 5G CN 310 (named at the moment in 3GPP as NGCN).

Further embodiments may avoid a need for support of doubled interface instances. application layer protocol terminations, and/or duplication of functions at the same RAN node 420. Further embodiments may also avoid a need to preconfigure supported functionality between RAN and CN, as discovery of such capabilities can be embedded in the new (unique) signaling protocol as an on-the-fly negotiation hence allowing for quick adaptation to a potentially heterogeneous UE population.

One or more embodiments discussed herein may also allow for a co-existence of legacy and new 5G functionality using the same protocol or interface 770, e.g., to allow for functional independence of new 5G functionality from legacy functionality while allowing backwards compatibility to be respected. Thus, legacy functionality may be kept with full backward compatibility while new functionality may be designed without constraints within the same signaling protocol, according to embodiments.

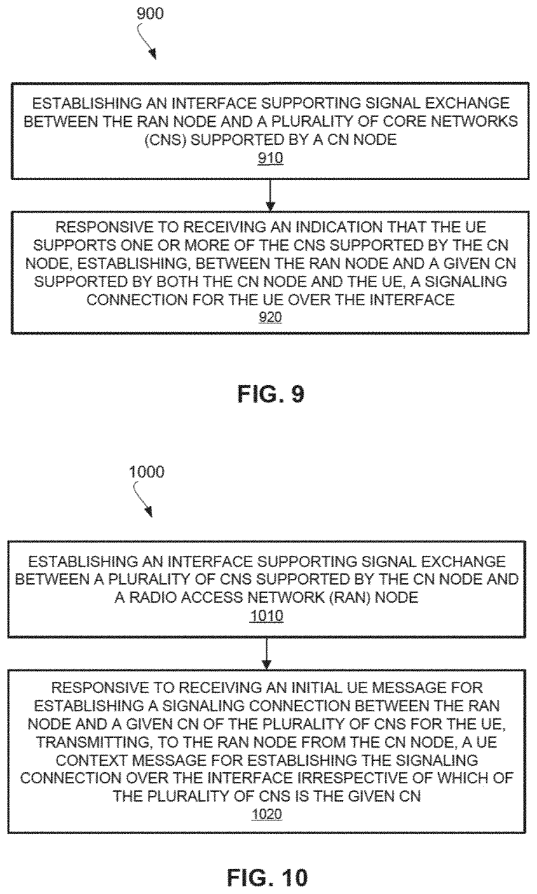

In view of all of the above, one particular embodiment of the present disclosure includes the method 900 of supporting signaling connection establishment for a UE 320, 325, as illustrated in FIG. 9. The method 900 is implemented in a RAN node 420. The method 900 comprises establishing an interface 770 supporting signal exchange between the RAN node 420 and a plurality of CNs 120, 710 supported by a CN node 405 (block 910). The method 900 further comprises, responsive to receiving an indication that the UE 320, 325 supports one or more of the CNs 120, 710 supported by the CN node 405, establishing, between the RAN node 420 and a given CN supported by both the CN node 405 and the UE 320, 325, a signaling connection for the UE 320, 325 over the interface 770 (block 920).

Another particular embodiment of the present disclosure includes the method 1000 of supporting signaling connection establishment for a UE 320, 325, as illustrated in FIG. 10. The method 1000 is implemented in a CN node 405. The method 1000 comprises establishing an interface 770 supporting signal exchange between a plurality of CNs 120, 710 supported by the CN node 405 and a RAN node 420 (block 1010). The method 1000 further comprises, responsive to receiving an initial UE message for establishing a signaling connection between the RAN node 405 and a given CN of the plurality of CNs 120, 710 for the UE 320, 325, transmitting, to the RAN node 420 from the CN node 405, a UE context message for establishing the signaling connection over the interface 770 irrespective of which of the plurality of CNs 120, 710 is the given CN.

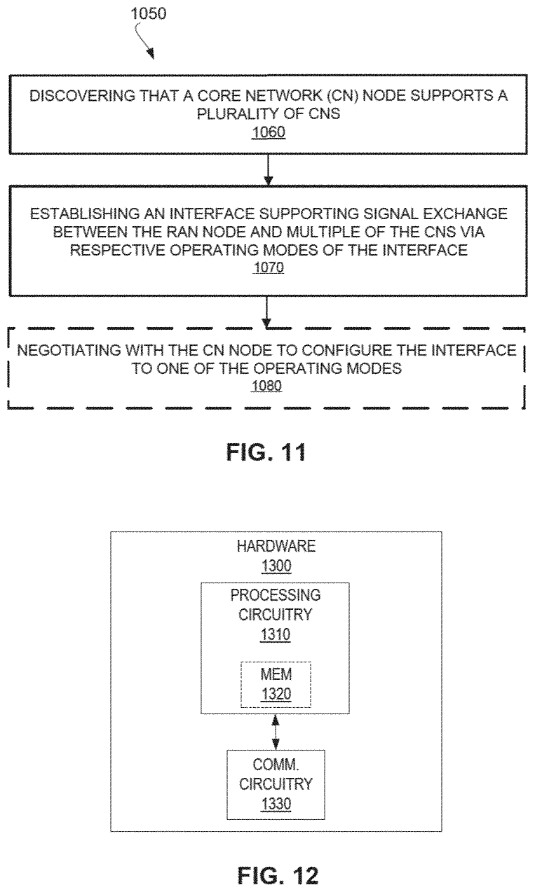

Yet another particular embodiment of the present disclosure includes the method 1050 of establishing an interface 770, as illustrated in FIG. 11. The method 1050 is implemented in a RAN node 420. The method 1050 comprises discovering that a CN node 405 supports a plurality of CNs 120, 710 (block 1060). The method 1050 further comprises establishing an interface 770 supporting signal exchange between the RAN node 420 and multiple of the CNs 120, 710 via respective operating modes of the interface 770 (block 1070). In some such embodiments, the method 1050 may additionally comprise negotiating with the CN node 405 to configure the interface 770 to one of the operating modes (block 1080).

Further, one or more of the nodes and/or methods described above may be implemented using the example hardware 1300 illustrated in FIG. 12. The example hardware 1300 comprises processing circuitry 1310 and communication circuitry 1330. The processing circuitry 1310 is communicatively coupled to the communication circuitry 1330, e.g., via one or more buses. The processing circuitry 1310 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 1310 may be programmable hardware capable of executing software instructions stored as a machine-readable computer program in memory circuitry 1320. The memory circuitry 1320 of the various embodiments may comprise any non-transitory machine-readable media known in the art or that may be developed, whether volatile or non-volatile, including but not limited to one or more hardware registers, solid state media (e.g., SRAM, DRAM, DDRAM, ROM, PROM, EPROM, flash memory, solid state drive, etc.). removable storage devices (e.g., Secure Digital (SD) card, miniSD card, microSD card, memory stick, thumb-drive, USB flash drive, ROM cartridge, Universal Media Disc), fixed drives (e.g., magnetic hard disk drive), and or any combination thereof.

The communication circuitry 1330 may be a controller hub configured to control the input and output (I/O) data paths of the hardware 1300. Such I/O data paths may include data paths for exchanging signals over a wireless communication network. For example, the communication circuitry 1330 may comprise a transceiver configured to send and receive communication signals within and/or between the RAN node 420 and the CN node 405, e.g., over an air, electrical, and/or optical medium.

Although some embodiments of the communication circuitry 1330 may be implemented as a unitary physical component, other embodiments of the communication circuitry 1330 may be implemented as a plurality of physical components that are contiguously or separately arranged, any of which may be communicatively coupled to any other, and/or may communicate with any other via the processing circuitry 1310. For example, in some embodiments, the communication circuitry 1330 may comprise transmitter circuitry (not shown) configured to send communication signals, and receiver circuitry (not shown) configured to receive communication signals.

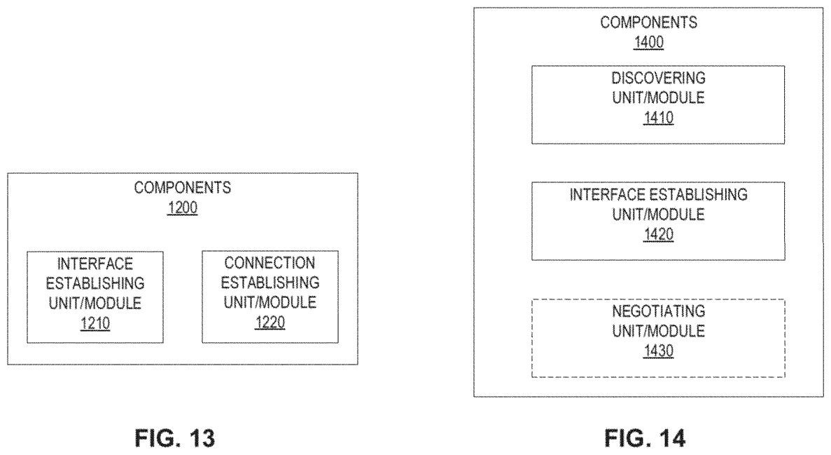

According to particular embodiments, the hardware 1300 illustrated in FIG. 13 may be configured with a plurality of components. These components may include a plurality of communicatively coupled hardware units and/or software modules. One or more of the hardware units may be, e.g., part of the processing circuitry 1310. One or more of the software modules may be, e.g., stored in the memory circuitry 1320 and executed by the processing circuitry 1310.

For example, the hardware 1300 may be comprised in a RAN node 420 and configured with the example components 1200 illustrated in FIG. 13. The components 1200 include an interface establishing unit or module 1210 and a connection establishing unit or module 1220. According to this example, the interface establishing unit or module 1210 is configured to establish an interface 770 supporting signal exchange between the RAN node 420 and a plurality of core networks (CNs) 120, 710 supported by a CN node 405. Further, the connection establishing unit or module 1220 is configured to, responsive to receiving an indication that the UE 320, 325 supports one or more of the CNs 120, 710 supported by the CN node 405, establish, between the RAN node 420 and a given CN supported by both the CN node 405 and the UE 320, 325, a signaling connection for the UE 320, 325 over the interface 770.

In an another example, the hardware 1300 may be comprised in a CN node 405 and configured with the example components 1200 illustrated in FIG. 13. According to this example, the interface establishing unit or module 1210 is configured to establishing an interface 770 supporting signal exchange between a plurality of CNs 120, 710 supported by the CN node 405 and a RAN node 420. Further, the connection establishing unit or module 1220 is configured to, responsive to receiving an initial UE message for establishing a signaling connection between the RAN node 420 and a given CN of the plurality of CNs 120, 710 for the UE 320, 325, transmitting, to the RAN node 420 from the CN node 405, a UE context message for establishing the signaling connection over the interface 770 irrespective of which of the plurality of CNs 120, 710 is the given CN.

In yet another example, the hardware 1300 may be comprised in a RAN node 420 and configured with the example components 1400 illustrated in FIG. 14. The components 1400 include a discovering unit or module 1410 and an interface establishing unit or module 1420. The discovering unit or module 1410 is configured to discover that a CN node 405 supports a plurality of CNs 120, 710. The interface establishing unit or module 1420 is configured to establish an interface 770 supporting signal exchange between the RAN node and multiple of the CNs 120, 710 via respective operating modes of the interface 770. In some embodiments, the components 1400 further include a negotiating unit or module 1080. The negotiating unit or module 1430 is configured to negotiate with the CN node 405 to configure the interface 770 to one of the operating modes.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1-22. (canceled)

23. A method, implemented in a radio access network (RAN) node, of supporting signaling connection establishment for a user equipment (UE), the method comprising the RAN node:
establishing an interface supporting signal exchange between the RAN node and a plurality of core networks (CNs) supported by a CN node;
responsive to receiving an indication that the UE supports one or more of the CNs supported by the CN node, establishing, between the RAN node and a given CN supported by both the CN node and the UE, a signaling connection for the UE over the interface.

24. The method of claim 23, wherein the establishing the signaling connection for the UE over the interface comprises:
sending, from the RAN node to the given CN, an initial UE message; and
receiving, at the RAN node from the given CN in response, a UE context message.

25. The method of claim 23, wherein the indication comprises an indication that the UE supports legacy Long-Term Evolution (LTE) functions, evolved LTE functions, and/or new radio (NR) functions.

26. The method of claim 23, wherein the indication comprises an indication that the UE supports Long-Term Evolution (LTE) non-stratum access (NAS) protocol or next generation NAS protocol.

27. The method of claim 23, wherein the establishing the signaling connection for the UE over the interface comprises initiating creation of a context for the UE.

28. The method of claim 23, wherein the establishing the signaling connection for the UE over the interface comprises selecting between a first and a second protocol for the signaling connection, each of the first and second protocols supporting signal exchange between the RAN node and a respective CN supported by the CN node.

29. The method of claim 28, wherein the first protocol is S1 Application Protocol and the second protocol is a next generation network layer signaling protocol.

30. A method, implemented in a core network (CN) node, of supporting signaling connection establishment for a user equipment (UE), the method comprising the CN node:
establishing an interface supporting signal exchange between a plurality of CNs supported by the CN node and a radio access network (RAN) node;
responsive to receiving an initial UE message for establishing a signaling connection between the RAN node and a given CN of the plurality of CNs for the UE, transmitting, to the RAN node from the CN node, a UE context message for establishing the signaling connection over the interface irrespective of which of the plurality of CNs is the given CN.

31. The method of claim 30, wherein the establishing the signaling connection over the interface comprises:
receiving, from the RAN node, an initial UE message; and
transmitting, to the RAN node from the given CN, a UE context message in response.

32. The method of claim 30, wherein the establishing the signaling connection for the UE over the interface comprises initiating creation of a context for the UE.

33. The method of claim 30, wherein the establishing the signaling connection for the UE over the interface comprises using either a first or a second protocol for the signaling connection based on whether the given CN is a first or a second one of the plurality of CNs, respectively.

34. The method of claim 33, wherein the first protocol is S1 Application Protocol and the second protocol is a next generation network layer signaling protocol.

35. The method of claim 30, wherein the establishing the interface comprises establishing a Stream Control Transmission Protocol association between the RAN node and the CN node as endpoints.

36. A radio access network (RAN) node supporting signaling connection establishment for a user equipment (UE), the RAN node comprising:
processing circuitry;
memory containing instructions executable by the processing circuitry whereby the RAN node is operative to:
establish an interface supporting signal exchange between the RAN node and a plurality of core networks (CNs) supported by a CN node; and
responsive to receiving an indication that the UE supports one or more of the CNs supported by the CN node, establish, between the RAN node and a given CN supported by both the CN node and the UE, a signaling connection for the UE over the interface.

37. A core network (CN) node supporting signaling connection establishment for a user equipment (UE), the CN node comprising:
processing circuitry;
memory containing instructions executable by the processing circuitry whereby the CN node is operative to:
establish an interface supporting signal exchange between a plurality of CNs supported by the CN node and a radio access network (RAN) node;
responsive to receiving an initial UE message for establishing a signaling connection between the RAN node and a given CN of the plurality of CNs for the UE, transmit, to the RAN node from the CN node, a UE context message for establishing the signaling connection over the interface irrespective of which of the plurality of CNs is the given CN.
